(19) United States
(12) Patent Application Publication
(10) Pub. No.: US 2012/0299674 A1
(43) Pub. Date: Nov. 29, 2012

(54) Gripole

(76) Inventor: Paul Montone, Deerfield Beach, FL (US)

(21) Appl. No.: 13/114,697

(22) Filed: May 24, 2011

(51) Int. Cl. H01F 7/02

(52) U.S. Cl. 335/285

(57) ABSTRACT

A Gripole has a first magnet encased in a first sheath that is in proximity to a first end of a thread that is attached to the first sheath. A second magnet encased in a second sheath that is in proximity to a second end of the thread that is attached to the second sheath. The first and second sheaths and thread are made from the group of sheath materials comprising: plastic, rubber and polymer materials. The first and second magnets may be brought together to hold an item. The first and second magnets may be attached to two different surfaces. The dual magnetic holder may be used in combination with one or more dual magnetic holder threaded through a loop formed by one or more holders. First and second magnets may be brought together to hold item(s) forming a loop by the thread surrounding a holding surface.

### CROSS REFERENCE TO RELATED APPLICATIONS

N/A

### STATEMENT REGARDING FEDERALLY SPONSORED RESEARCH OR DEVELOPMENT

N/A

### COPYRIGHT NOTICE

A portion of the disclosure of this patent document contains material that is subject to copyright protection. The copyright owner has no objection to the facsimile reproduction by anyone of the patent document or patent disclosure as it appears in the United States Patent and Trademark Office patent file or records, but otherwise reserves all copyrights whatsoever.

### BACKGROUND

(1) Field of the Invention

Relating to improvements in devices designed to hold items. More specifically, relating to improvements in devices that utilize magnets to hold items.

(2) Related Art

U.S. Pat. No. 3,756,252 to Vigorito teaches a cigarette holder having a base retaining a magnet element and an upstanding stem portion which cooperates with a pivotally mounted and spring-urged clamp. At least the stem and clamp being formed of metal to extinguish the cigarette when the burning end approaches the position of engagement with the clamp. The stem has a forward end that is positioned above the base in cantilevered fashion and extends in a generally horizontal direction beyond the confines of the base, terminates in a downwardly directed lip and has a pair of upstanding ears rearward of the lip and extends upwardly at least the distance of the diameter of a cigarette, said clamp has an upturned lip at the forward end thereof and a pair of depending ears mating with the ears on the stem, a pivot pin extending through said ears and a coil spring surrounding the pin and urging the forward end of the clamp into engagement with the forward end of the stem.

U.S. Pat. No. 3,955,315 to Goodman teaches an article for use as a novelty to provide amusement and interest in the movement of magnets supported therein, which includes an upper magnet suspended by a line from the upper portion of a frame and magnetized so that opposite faces define poles of opposite polarity, and a lower magnet connected by a line to the lower portion of the frame and magnetized so that opposite faces define poles of opposite polarity, which lower magnet is oriented with respect to the upper magnet so that the poles of the upper and lower magnets which are facing each other are of opposite polarity so that the upper and lower magnets attract each other when the lower magnet is positioned proximate to the upper magnet, and which line connecting the lower magnet to the frame is of a length such that the lower magnet is restrained from contacting the upper magnet when the line is fully extended upon positioning the lower magnet proximate to the upper magnet. The magnets are both freely movable in relation to the lines to which they are secured, which lines are both freely flexible.

U.S. Pat. No. 4,527,775 to Flowers teaches an apparatus for installing conduit in a confined wall space are disclosed. A tape is introduced into the confined space behind the wall and is extended to an outlet point by moving a tool along the exterior wall surface. The tool has an electromagnet which attracts a metal roller on the end of the tape, drawing the roller against the interior wall surface. The tool has rollers, or wheels, allowing it to roll on the exterior wall surface, and hence the extension of the tape is by means of combined roller action on both surfaces of the wall. At the outlet, conduit is attached to the tape and is pulled into the confined space by retracting the tape. Retraction of the tape may be accomplished by a drum onto which the tape is wound.

U.S. Pat. No. 6,886,793 to Snell teaches an invention that provides a suction cup assembly having a magnetic tether system attached to a suction cup. The assembly includes a resilient suction cup, tether, holder and magnet. This assembly enables a suction cup to hold items on non-magnetic, smooth surfaces using a magnet.

U.S. Pat. No. 7,093,822 to Welker teaches a magnetic wire pulling system advances wire through a house or other structure around obstacles with a string tied to a pulling cord then tied to the wire. The system has small, medium, and large magnets, and tools attracted to the magnets. The round small and medium magnets are tied upon strings wound upon spools. The spools have pins to secure magnets. The tools comprise a retrieval tool, a manual release tool, an insertion tool, an automatic release tool, a transfer tool, an extensible prop, and a telescoping pole with magnet. The tools deliver a magnet into the structure of a house, retrieve a magnet from the structure, or transfer a magnet from one tool to another tool. In operation, a bigger magnet attracts a smaller magnet or a magnet attracts a tool to advance a string beyond an obstacle to continue pulling wire.

U.S. Pat. No. 7,758,021 to Welker teaches a tool that has a cylinder with a pair of magnets, diametrically spaced apart upon the sides of the cylinder and of opposite polarity. In cooperation with a compass, the magnets identify the tool thus indicating its location when concealed prior to pulling wire through a house or other structure. The tool also spaces a bit extension tool away from interior faces of adjacent drywall panels. A setscrew secures the cylinder upon the shank of a bit extension for rotation of the tool. The magnets are integrated into the cylinder of the tool to survive ordinary handling, drilling through wooden structures, and rotation. The tool emanates a magnetic field from within a concealed location that deflects a compass for revealing the location of the tool.

U.S. Pat. No. 7,762,530 to Kim teaches a device for running a line under carpet, through drywall, or through any other thin, non-magnetic barrier. The device uses a strong super magnet that is attached to a handle, which also serves as a storage container for the line pulling device, as well as a mechanism to pull the line with adequate force without causing pain to the puller's hands.

US patent application 2009/0013720 to Altick teaches an improved jewelry clasp. In particular, the present invention is directed to a jewelry clasp that allows for stringing objects but secures strung objects when removed from a user's neck. A preferred embodiment of the invention is a necklace with threaded ends. Each end preferably is threaded into a threaded section rotatably attached to a magnet. Each magnet is magnetically and removeablely attached to the other magnet. Thus, beads or other objects can be strung onto one threaded end of the necklace and then secured by the threaded section and clasped with the magnets.

US patent application 2009/0255122 to Azrielant teaches an earring that is convertible to a bracelet and vice versa is provided. The design comprises a chain of any type with magnetic clasps affixed at either end. Each earring may be attached to a person's ear lobe by using the magnetic elements in each clasp—the magnet elements attract one another when each clasp is fixed on either side of the earlobe. Alternatively, the two earrings can be coupled together in order to form a bracelet. Corresponding clasps from each of the earrings are mated together (via their internal magnets) in order to form a pair of decorative globes.

None of the cited prior art teaches an easy to use, portable device that can be utilized to hold a variety of items. Neither does the prior art teach an inexpensive device that can be utilized to hold a variety of items.

### BRIEF SUMMARY OF THE INVENTION

A dual magnetic holder comprising a first magnet encased in a first sheath that is in proximity to a first end of a thread that is attached to the first sheath. Also, a second magnet encased in a second sheath that is in proximity to a second end of the thread that is attached to the second sheath. The first sheath is made from the group of sheath materials comprising: plastidip, plastic, rubber and polymer materials. The second sheath is made from the group of sheath materials comprising: plastidip, plastic, rubber and polymer materials. The thread is made from the group of thread materials comprising: stretch magic, plastidip, plastic, rubber and polymer materials. The first and second magnets may be brought together to hold an item. The first and second magnets may be attached to two different surfaces. The dual magnetic holder may be used in combination with another dual magnetic holder threaded through a loop formed by the first dual magnetic holder magnetic attachment of its end magnets. The first and second magnets may be brought together to hold an item such that a loop formed by the thread surrounds a holding surface.

A dual magnetic holder comprising a first magnet encased in a first sheath portion that is in proximity to a first end of a thread portion that is attached to the first sheath portion. Also, a second magnet encased in a second sheath portion that is in proximity to a second end of the thread portion that is attached to the second sheath. The first sheath, the second sheath and the thread portion are formed from a single integral piece of material. The single piece of material is made from the group of thread materials comprising: plastidip, plastic, rubber and polymer materials. The first and second magnets may be brought together to hold an item. The first and second magnets may be attached to two different surfaces. The dual magnetic holder may be used in combination with another dual magnetic holder threaded through a loop formed by the first dual magnetic holder magnetic attachment of its end magnets. The first and second magnets may be brought together to hold an item such that a loop formed by the thread surrounds a holding surface. Further, the thread portion is from the thread portion types comprising: a thread portion integral with and made from the same material as the sheaths, i.e. plastidip, a thread portion made solely from stretch magic, a thread portion made solely from stretch magic attached to the magnets through melted end portions, and a thread portion made from stretch magic and held in union with the sheaths by an overlaid portion of plastidip that is integral with the sheaths portions.

A dual magnetic holder comprising a first magnet encased in a first sheath that is in proximity to a first end of a thread that is attached to the first sheath; a second magnet encased in a second sheath that is in proximity to a second end of the thread that is attached to the second sheath. The thread and sheaths are formed of materials made from the group comprising: plastidip, plastic, rubber and polymer materials. The sheaths and the thread may optionally form a single uniform piece of material.

### BRIEF DESCRIPTION OF THE SEVERAL VIEWS OF THE DRAWINGS

FIG. 1 illustrates an embodiment and its various component parts. The figure also shows the complete union of the various component parts.

FIG. 2 illustrates a dual device usage including the holding of cloth material such as a towel.

FIG. 3 illustrates two different molding apparatus for use in the manufacture of the device.

FIG. 4 illustrates another embodiment in its various component parts. The figure also shows the complete union of the various component parts.

FIG. 5 illustrates a single device usage including the holding of an article such as some glasses around the rear view mirror of a car.

### DETAILED DESCRIPTION OF THE INVENTION

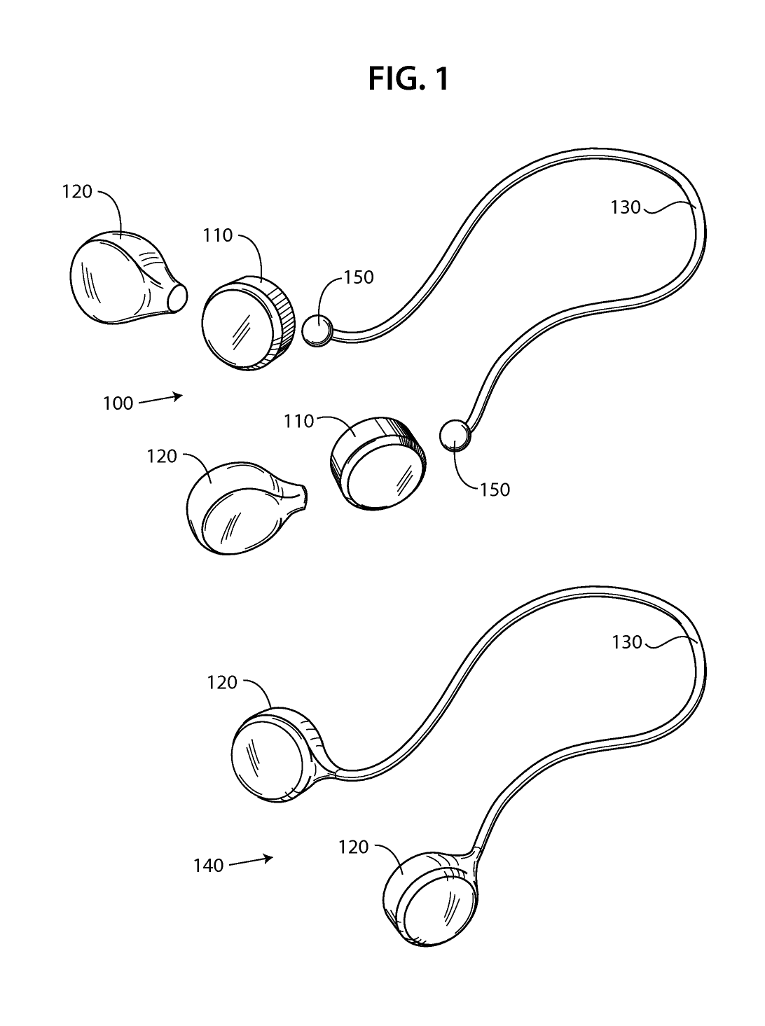

FIG. 1 illustrates an embodiment and its various component parts. The figure also shows the complete union of the various component parts. A Dual Magnetic Thread Holder or Gripole 100 is described as shown in FIG. 1 having a thread 130 made of a plastic, rubber, silicone, polymer or similar material. In the initial implementation of the device the material used to make this thread 130 is called Stretch Magic® a registered trademark of Peperrell Braiding Company. This thread is of such a composition that it is super strong, can be clear and or opaque and is an optimal elastic cord for jewelry making. In this particular usage it will be used to hold the ends of two magnets. To hold the two ends of the Thread Magic 130 to one magnet at each end, a user treats each end of the thread 130 with a heat source or gun so as to create a ball of melted 150 Stretch Magic thread material at each end of the thread 130. A user then presses each melted end to the flat end of magnets 110. Thus, these two solid disk magnets 110 are also disposed at the opposite ends of thread 130. Also shown in the figure are two plastic, rubber or polymer sheaths 120 that are formed such that they entirely enclose the respective magnets 110 that are disposed at the ends of thread 130. The device is completed 140 by the plastic, rubber or polymer sheaths 120 completely encasing the two solid disk magnets 110 such that the plastic, rubber or polymer comprising the sheaths 120 also acts to hold the ends of thread 130 to the sheaths 120. However, it should be understood that in this implementation it is the melted ends 150 that carry most of the holding power of the thread 130 to the magnets 110.

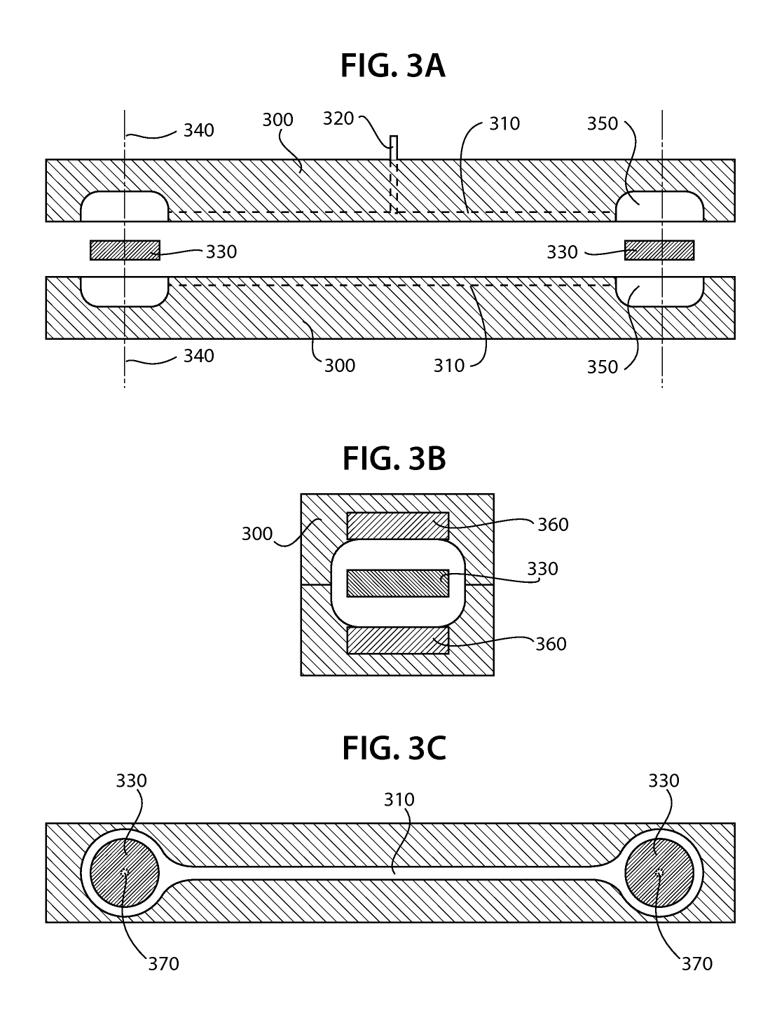

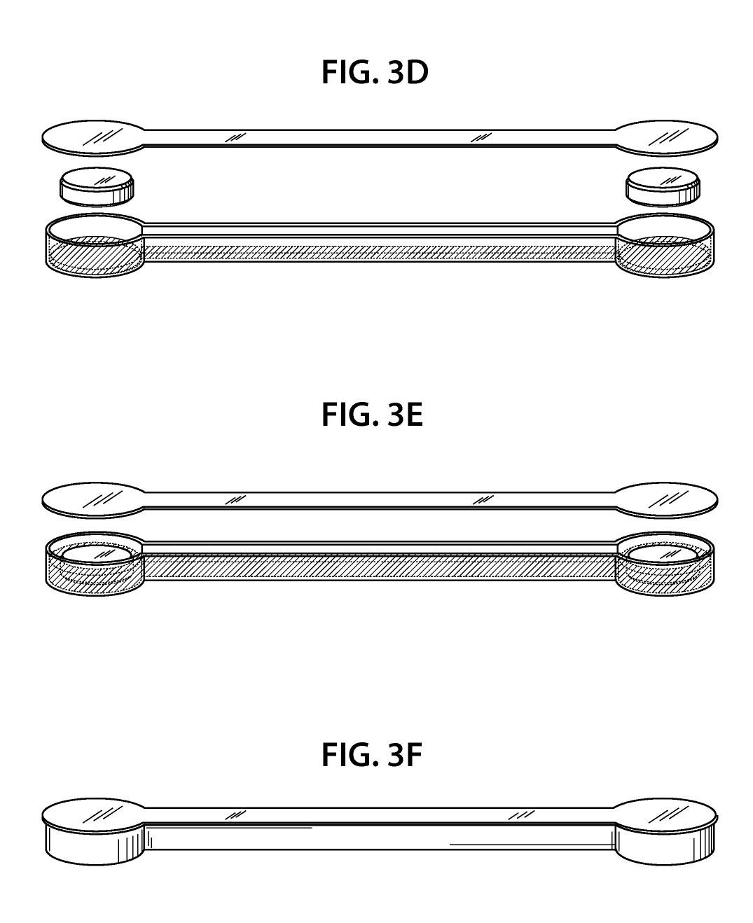

In one implementation, the sheaths 120 are made of a material known as Plastidip® that can be found at (http://www.Plastidip.com) and are made from materials that provide excellent coatings to devices and come in a variety of colors. To form the sheath about each magnet several different techniques are utilized as described in the following and in connection with FIG. 3. One way to dip the thread 130 and attached magnets 150 is to make notches in a tile working trowel on opposite sides of the trowel; these form good opposite locations to place the two necks of each individual thread (near the magnet ends) in each notch with each magnet hanging outside of and disposed underneath the notch with and with respect to the trowel handle. The thread itself spreads out over the trowel top and prevents the entire device from disengaging from the dipping trowel. Previous to this arrangement, a user has prepared two dipping troughs filled with the Plastidip material that are separated by an appropriate amount of space. He or she then dips the magnet heads on one side of the trowel into one trough and the other magnet heads on the opposite side of the trowel into the other trough. Thus the sheaths are dip formed about the magnets and are placed in drying trays specifically manufactured for this purpose. It should be noted that the Plastidip material can end directly about the magnet heads or the user can dip the magnets in the troughs sufficiently that it spreads up and over the Stretch Magic thread 130. Other techniques for the forming of the device are herein described with connection to FIG. 3.

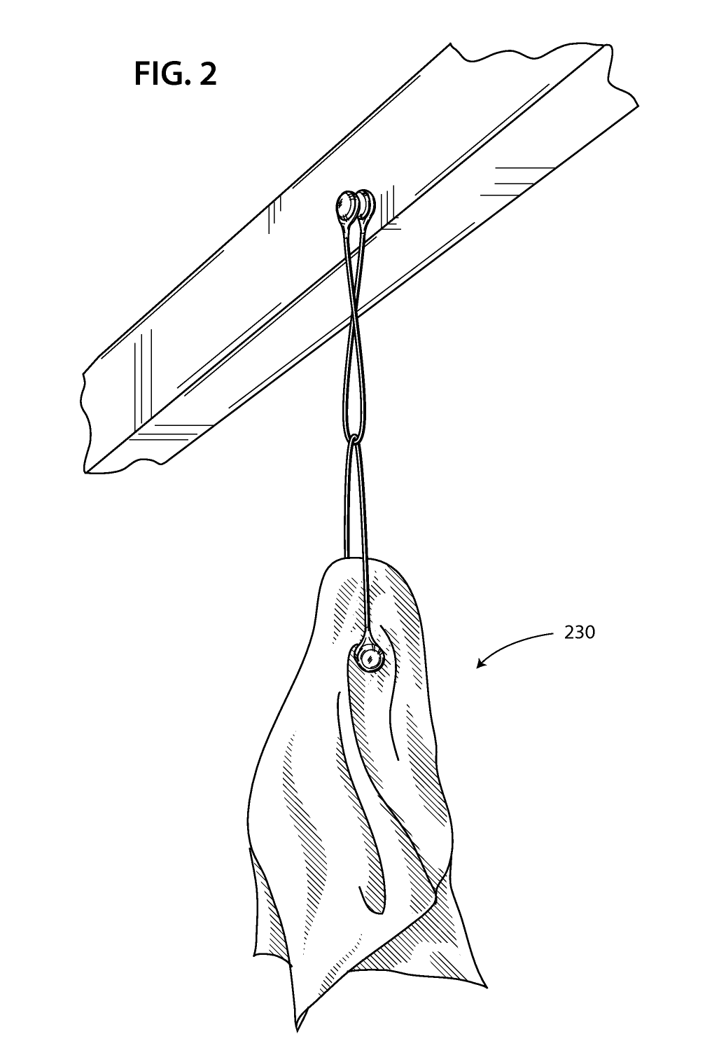

The Gripole device as described herein utilizes its magnetic properties to grasp items between its two ends thus imparting some friction to item(s) or it holds item(s) solely through the use of its magnets. In FIG. 2, for example, the Gripole's long thread length is literally threaded about a holding device. In this case, it is using another Gripole device as a holding device. This second device is magnetically attached at its two magnetic ends to a magnetic bar attached to a piece of equipment. The first Gripole is threaded through the bowed section of the second one and holds a piece of cloth between its magnets that have been brought in close proximity to one another about the cloth as shown in 230. Thus, its two magnet holding sheaths are brought together and placed in physical proximity to an item with suitable magnetic properties. These devices are suitable for single usage or in combination with other Gripole devices. Several other uses include the holding of clothing, tools, sticky notes and a dual or multiple holding implementation for heavy items and items that need more thread length where more than one Gripole forms a holding point and more than one Gripole actually grips the item. In this drawing is illustrated a dual device usage including the holding of cloth material. Other uses include the dual magnetic holder device or Gripole described herein being looped through the hoops at the edge of a pair of pants. The pants are then hung from a shower curtain rod such that the magnetic ends of the device are in contact with each other. Another demonstration of the unique holding power of the dual magnetic device holder has the device restraining the fall of several mechanics tools at the ends of a couple of holders that have themselves been magnetically attached to a car hood with the other end of the devices. In another example, the dual magnetic holder is looped about the neck of a rear view mirror. The ends of the device are brought together to hold a piece of paper or paper notes.

The embodiments described herein are capable of holding a variety of items using either a single or multiple holder implementation. Some of the items that are attachable using the simple magnetic holder(s) include but are not limited to: Christmas Lights to a tree or exterior surface of a house; the hanging of clothes to a clothesline shower rod; pen holder to a desk; wine glass marker holder; general office holder to suitable material or device; car; IV lines, hospital; tooth brush; grilling utensils; chip clip; reminders on refrigerator; hats; dog leash; sign holder; golf cart towel; oven mit; oven towel; keys; wine opener; page holder; money clip; hair. The device described herein is also works underwater because of the nature of the material from which it is made.

An optional alternative to the above is that the entire FIG. 140 describes one single piece of plastic, rubber or polymer like Plastidip holding the two disk magnets and Stretch Magic thread together. In this case, the two solid disk magnets 330 as shown in FIG. 3A are dipped into the ends of a two-sided form or die 300 that have been suitably prepared with two disk cavities 350 at either end. In this case, the stretch magic thread 130 is placed inside a holder 310 trough at the center of the form or die that guides the insertion of the opposite ends of the thread 130 into the disk cavities at opposite ends of the die or form such that the thread ends pass through the respective side of the respective disk cavity's portion of the form or die at a mid point thereof. Initially, a certain amount of plastic, rubber or polymer like Plastidip is placed into the die or form at the bottom of each disk cavity 350 and central trough 310 and then a machine tool (one option is a holding pin 340 is threaded through a tiny hole in the top and optionally the bottom of the die 300 to position the magnets properly then retracted through the hole when no longer used; cut through user interaction or through another machine tool) or user places the two magnets inside each disk cavity form 350 or die.

The technician then either manually or through the use of a machine tool lowers the top cover of the form or die 300 onto the other portion of the form. The next step in the process would require the insertion of the final portion of the material (plastic, rubber or polymer) through injection port 320 and into each of the disk cavity's forms 350 and trough form 310 all the while ensuring that sufficient material surrounds the thread 130 so as to form a tight hold to both magnets. In this fashion, a sheath is shaped about magnets 110, 330 from the disk cavity die or form 300. 310, 350 and about the entire length of the thread forming one long Plastidip sheath about magnets including a long sheath about Stretch Magic thread. Alternatively, no stretch magic thread is utilized in the trough 310 and the only material holding the two magnets together is the Plastidip type material.

FIG. 3B illustrates an optional alternative of forming the device by utilizing two forms 300 having top and bottom magnets embedded within the troughs to help position the magnets 330 as shown. FIG. 3C illustrates the central trough 310 for the Stretch Magic thread and Plastidip lengthwise sheath or the Plastidip without Stretch magic optional mechanism. Additionally, the figure shows the magnets centrally positioned with room for a sheath of plastidip about each magnet 330 and arranged using holding pins 370 that are cut using a machine tool or user interaction (knife, pliers etcetera). When the form dries, any excess material is shaved off with appropriate tools (knife etcetera). The entire device has the option of having no Stretch Magic cord within the body of the Plastidip sheath that extends the length of the Gripole. Of course, the other option is to have that Stretch Magic thread included in the mold as described previously so that you would have a sheath about magnets and Stretch Magic thread. In the event that the Stretch Magic thread is not included a molded Plastidip cord or thread is formed between the sheath encased magnets and forms one uniform integral piece with the Plastidip sheaths about each magnet.

FIGS. 3D, 3E and 3F describes another molding design that is used in connection with creating the Gripole; in this implementation, the entire FIG. 140 describes one single piece of plastic, rubber, polymer or Plastidip material holding the two disk magnets at the ends 120 as shown. In either case, the two solid disk magnets are dipped into the ends of a form or die that has been suitably prepared with two disk cavities at either end. In this second case, the central thread 130 has not been preformed in another separate die. Rather the dual cavities die or form are integral with a form or die having a central oblong region. In other words, there is a single die or form for the entire piece. Here, the cavities at either end have connected with then a central oblong region in the form or die that shapes the plastic, rubber or polymer material placed herein into an appropriate shape. Initially, a certain amount of plastic, rubber or polymer is placed into the die or form at the bottom of each disk cavity and down the central oblong region and then a machine tool or user places the two magnets inside each disk cavity ends of the form or die. The technician would then either manually or through the use of a machine tool cover the form or die with the top portion of the entire form. The next step in the process would require the insertion of the final portion of the material (plastic, rubber or polymer) into the form or die while ensuring that sufficient material surrounds the magnet(s) 110 so as to form a tight hold to both magnets. In this fashion, one solid piece 140 is shaped including magnets 110 in the end sheaths 120 that are integral with the thread 130 in one solid plastic, rubber or polymer piece like Plastidip. It should be clear that the thread 130 is created from one solid plastic, rubber, polymer, Plastidip piece along with sheaths 120. An alternative is to include that Stretch Magic thread therein as well as a sheath of Plastidip about the thread and magnets.

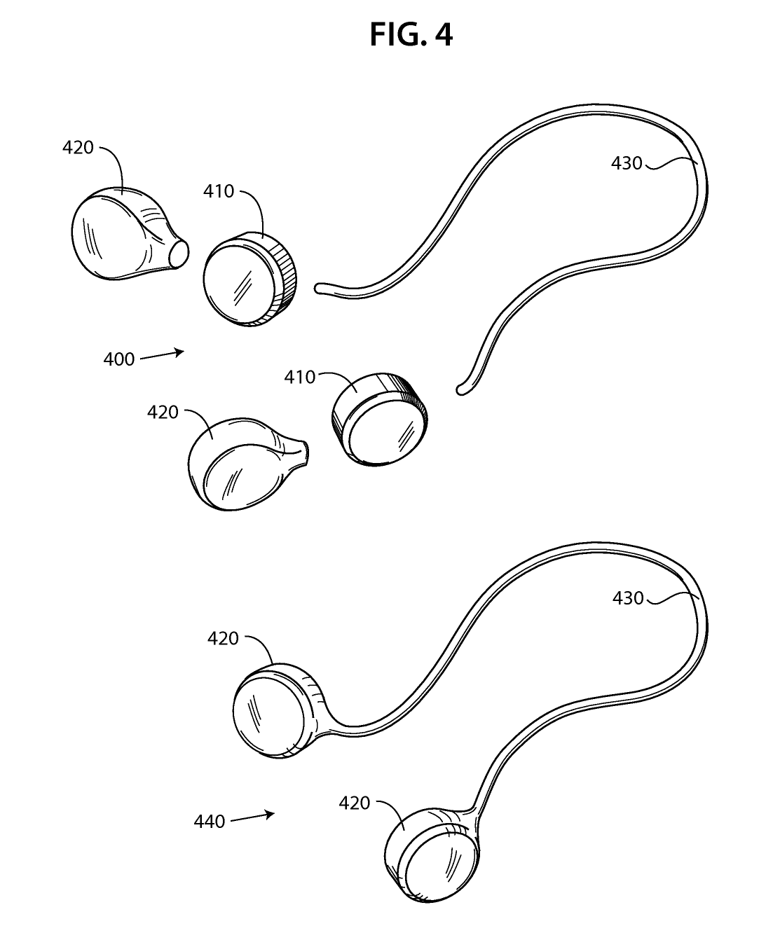

FIG. 4 illustrates an embodiment and its various component parts. The figure also shows the complete union of the various component parts. A Dual Magnetic Thread Holder or Gripole 400 is described as shown in FIG. 4 having a thread 430 made of a plastic, rubber, silicone, polymer, Strech Magic or similar material. In the initial implementation of the device the material used to make this thread 430 is called Stretch Magic® a registered trademark of Peperrell Braiding Company. This thread is of such a composition that it is super strong, can be clear and or opaque and is an optimal elastic cord for jewelry making In this particular usage it will be used to hold the ends of two magnets. To hold the two ends of the Thread Magic 430 to one magnet at each end, the user implements this through the use of sheaths 420 that are formed using techniques described in connection with FIGS. 3A-3F.

Also shown in the figure are two plastic, rubber, Plastidip or polymer sheaths 420 that are formed such that they entirely enclose the respective magnets 410 that are disposed at the ends of thread 430. The device is completed 440 by the plastic, rubber or polymer sheaths 420 completely encasing the two solid disk magnets 410 such that the plastic, rubber, Plastidip or polymer comprising the sheaths 420 also acts to hold the ends of thread 430 to the sheaths 420. Alternatively, the thread is made up of the same material as the sheath and a separate thread of Stretch Magic is not included.

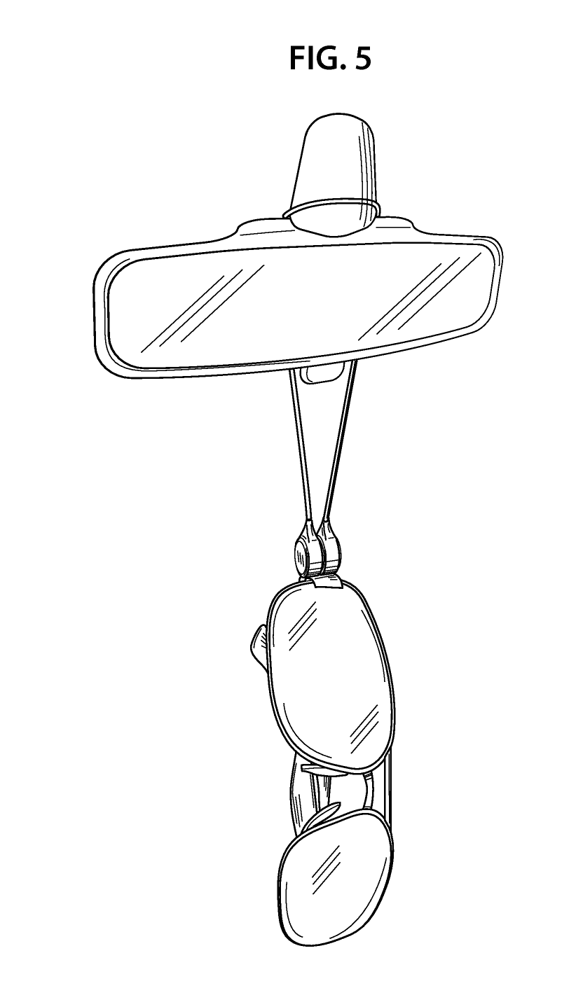

FIG. 5 illustrates a single device usage including the holding of an article such as some glasses around the rear view mirror of a car. The thread holding the two magnets together are threaded about the rear view mirror holder that is attached to the inner windshield of a motor vehicle. The magnets are placed in physical contact with the glasses using the inherent magnetic properties of the Gripole and materials in this set of glasses.

VARIOUS VARIATIONS: The stops 150 at the end of the central cord can be made from any shapes or sizes and that it can be accomplished from other means such as crimping a piece of metal to it; that is a separate piece of material, not just using the cord. Also it can be created (150 the stop) from the cord itself by heating or bending the end of the cord and gluing it to itself or whatever would create the stop/bulge. For example, if using a metal aid, then the crimped metal would act as the stop and the magnet would then stick to the metal to be dipped. If aluminum or any type of metal is used for cord stop it can also be attached to cord with glue or adhesive in addition to crimping. Depending on the metal used being magnetic or non magnetic, the magnet can be attached to the cord stop/end by, magnetic force if the metal used is magnetic as mentioned therein, the magnet can be attached with glue or adhesive if metal used is non magnetic such as aluminum. Of course, then the part is dipped in the sheathing material to complete the piece. Also, when using a magnet with a hole all the way through the cord can be threaded through and a stop or bulge created as mentioned or fastened with some means such as a knot or epoxy to prevent the cord from backing out of the hole. Also, if a magnet has a blind hole or hole that doesn't go completely through the magnet then the cord could be attached with epoxy or adhesive by inserting the cord into the hole. Magnets can be made of various sizes and shapes, and magnet ends can be combined with different shapes, such as one end being disc shape and the other end being square. The central cord or thread can be made from: stretch magic, string, fiber, wire, rope, or any other material. The sheathing can be optionally made from: plastidip plastics, metal coatings, fiber, clothes, fabrics, or any other material that is suitable for the coating of a surface such as described herein. The cord is optionally attached to a magnet by the wrapping of the thread or cord around the magnet. The various embodiments and optional variations are interchangeable in any combination.

The invention has thus been described in such clear and precise terms as to enable one of ordinary skill in the art to understand its fundamental principles.

1. A dual magnetic holder comprising:
a first magnet completely encased in
a first sheath that is in proximity to a first end of
a thread that is attached to the first sheath.

2. The dual magnetic holder of claim 1, further comprising:
a second magnet encased in
a second sheath that is in proximity to a second end of
the thread that is attached to the second sheath.

3. The dual magnetic holder of claim 1 wherein the first sheath is made from the group of sheath materials comprising: plastidip, plastic, rubber and polymer materials.

4. The dual magnetic holder of claim 2 wherein the second sheath is made from the group of sheath materials comprising: plastidip, plastic, rubber and polymer materials.

5. The dual magnetic holder of claim 1 wherein the thread is made from the group of thread materials comprising: stretch magic, plastidip, plastic, rubber and polymer materials.

6. The dual magnetic holder of claim 2 wherein the first and second magnets are brought together to hold an item.

7. The dual magnetic holder of claim 2 wherein the first and second magnets are attached to two different surfaces.

8. The dual magnetic holder of claim 2 wherein the dual magnetic holder is used in combination with another dual magnetic holder threaded through a loop formed by the first dual magnetic holder magnetic attachment of its end magnets.

9. The dual magnetic holder of claim 2 wherein the first and second magnets are brought together to hold an item such that a loop formed by the thread surrounds a holding surface.

10. A dual magnetic holder comprising:
a first magnet completely encased in
a first sheath portion that is in proximity to a first end of
a thread portion that is attached to the first sheath portion.

11. The dual magnetic holder of claim 10, further comprising:
a second magnet encased in
a second sheath portion that is in proximity to a second end of
the thread portion that is attached to the second sheath.

12. The dual magnetic holder of claim 11 wherein the first sheath, the second sheath and the thread portion are formed from a single integral uniform piece of material.

13. The dual magnetic holder of claim 12 wherein the single integral uniform piece of material is made from the group of thread materials comprising: plastidip, plastic, rubber and polymer materials.

14. The dual magnetic holder of claim 11 wherein the first and second magnets are brought together to hold an item.

15. The dual magnetic holder of claim 11 wherein the thread portion is from the thread portion types comprising: a thread portion integral with and made from the same material as the sheaths, i.e. plastidip, a thread portion made solely from stretch magic, a thread portion made solely from stretch magic attached to the magnets through melted end portions, and a thread portion made from stretch magic and held in union with the sheaths by an overlaid portion of plastidip that is integral with the sheaths portions.

16. The dual magnetic holder of claim 11 wherein the dual magnetic holder is used in combination with another dual magnetic holder threaded through a loop formed by the first dual magnetic holder magnetic attachment of its end magnets.

17. The dual magnetic holder of claim 11 wherein the first and second magnets are brought together to hold an item such that a loop formed by the thread surrounds a holding surface.

18. A dual magnetic holder comprising:
a first magnet completely encased in
a first sheath that is in proximity to a first end of
a thread that is attached to the first sheath;
a second magnet encased in a
a second sheath that is in proximity to a second end of
the thread that is attached to the second sheath.

19. The dual magnetic holder of claim 18, wherein the thread and sheaths are formed of materials made from the group comprising: plastidip, plastic, rubber and polymer materials.

20. The dual magnetic holder of claim 18, wherein the sheaths and the thread form a single uniform piece of material.
